(19) United States
(12) Patent Application Publication
(10) Pub. No.: US 2014/0224774 A1
(43) Pub. Date: Aug. 14, 2014

(54) Method and Device for Joining a Composite Sheet-Metal Part

(71) Applicants: Azeddine Chergui, Dortmund (DE); Robert Klimek, Dortmund (DE)

(72) Inventors: Azeddine Chergui, Dortmund (DE); Robert Klimek, Dortmund (DE)

(73) Assignee: THYSSENKRUPP STEEL EUROPE AG, Duisburg (DE)

(21) Appl. No.: 14/006,195

(22) PCT Filed: Apr. 23, 2012
(86) PCT No.: PCT/EP2012/057359

§ 371 Date: Nov. 25, 2013

(30) Foreign Application Priority Data
May 4, 2011 (DE) 10 2011 100 495.9

(51) Int. Cl. B23K 11/16; B23K 11/36; B23K 11/11

(52) U.S. Cl. CPC B23K 11/16; B23K 11/115; B23K 11/36
USPC 219/91.2; 219/86.1; 219/127

(57) ABSTRACT

There is illustrated and described a method for joining a composite sheet metal member to an additional component, the composite sheet metal member having at least two outer covering metal sheets and at least one non-metal layer which is arranged between the covering metal sheets and the additional component having at least one outer metal layer, wherein the composite sheet metal member and the additional component are moved so as to overlap each other between two electrodes of a resistance welding unit. In order to be able to join composite sheet metal members in an operationally reliable manner by means of resistance welding, there is provision for an electrically conductive dummy element to be moved into abutment with an outer covering metal sheet and for at least one current path between the two electrodes to be closed by means of an electrically conductive dummy element.

The invention relates to a method for joining a composite sheet metal member to an additional component, the composite sheet metal member having at least two outer covering metal sheets and at least one non-metal layer which is arranged between the covering metal sheets and the additional component having at least one outer metal layer, wherein the composite sheet metal member and the additional component are moved so as to overlap each other between two electrodes of a resistance welding unit. The invention further relates to a device for joining a composite sheet metal member to an additional component, the composite sheet metal member having at least two outer covering metal sheets and at least one non-metal layer which is arranged between the covering metal sheets and the additional component having at least one outer metal layer, having a resistance welding unit comprising at least two electrodes.

Composite sheet metal members are composite materials which are constructed in particular in the form of a sandwich. Composite sheet metal members mostly comprise two outer covering metal sheets and a plastics material layer which is arranged between the covering metal sheets. Owing to the layered structure of the composite sheet metal members, they may have properties which could not be achieved or could hardly be achieved with a component of a uniform material. Composite sheet metal members may, for example, have very high levels of local rigidity and strength. In addition, composite sheet metal members may provide good sound-damping properties. Not least, however, composite sheet metal members also enable a lower component weight, without losses in terms of the remaining properties of the component having to be accepted. For this reason, composite sheet metal members are increasingly used as so-called lightweight metal sheets in automotive construction.

It is disadvantageous that the composite sheet metal members are only suitable to a limited extent for the resistance welding which is widely used in automotive construction. Resistance welding is used, for example, in order to connect the composite sheet metal members to normal sheet metal components in a simple and cost-effective manner. During resistance welding, there is a brief high introduction of heat into the composite sheet metal member, whereby the at least one non-metal layer which is arranged between the covering metal sheets can easily be damaged. This is particularly the case with plastics material layers, which have a lower temperature resistance and additionally a lower temperature conductivity than the outer covering metal sheets. The plastics material layers may in addition be electrically insulating or in any case have a very low electrical conductivity.

An object of the present invention is therefore to configure and develop the method and the device of the type mentioned in the introduction and described in greater detail above in such a manner that composite sheet metal members can be joined in an operationally reliable manner by means of resistance welding.

This object is achieved according to claim 1 by a method of the type mentioned in the introduction, in which an electrically conductive dummy element is moved into abutment with an outer covering metal sheet and in which at least one current path between the two electrodes is closed by means of an electrically conductive dummy element.

The invention has consequently recognised that, in order to protect the composite sheet metal member when being joined in regions which are particularly subjected to local stresses, a dummy element can be used which is moved into contact with the composite sheet metal member. The dummy element is electrically conductive and preferably thermally very stable. The dummy element may, for example, be very similar to the covering metal sheet with regard to these properties. If necessary, the dummy element and the outer covering metal sheets may be produced from the same or similar material. However, there may also be provision for the dummy element to have a significantly higher level of conductivity and/or significantly higher level of thermal stability. It may then be sufficient to improve the material quality of the dummy element in place of the outer metal covering sheet.

During resistance welding, at least two electrodes are positioned with respect to the workpieces to be welded in such a manner that there is formed between the electrodes an electrically conductive connection, a so-called current path, which extends through at least one of the workpieces. The workpieces are in this instance the composite sheet metal member and the other component. The electrodes may be constructed differently and, for example, as part of a set of welding pincers or as rolling electrodes.

The dummy element is moved into at least one current path which is formed during the resistance welding operation. Ultimately, the current path is thereby closed by means of the dummy element, even if the current path can be closed in a different manner with or without the dummy element.

Consequently, at least a portion of the current flows through the dummy element, whereby less heat is introduced into the composite sheet metal member. The dummy element may simulate a local thickened portion and consequently a greater sheet metal thickness of an outer metal covering sheet. The thickening in a locally narrowly limited region is sufficient in order to reduce the introduction of heat, in particular into the non-metal layer of the composite sheet metal member, without impairing the actual joining of the workpieces.

In addition, the use of a dummy element prevents unnecessary material requirement. The dummy element is distinguished in that it is preferably dispensable for the mechanical and other properties of the composite sheet metal member. The dummy element needs to be provided only at locations where locally increased temperatures may occur during the resistance welding operation. Other circumstances therefore do not need to be taken into account or hardly need to be taken into account. Therefore, it can also be tolerated when the dummy element is not permanently connected to the composite sheet metal member by means of resistance welding, but instead sooner or later falls or is removed from the composite sheet metal member. The dummy element can, for example, be brought into contact with the composite sheet metal member only for the duration of the resistance welding operation, that is to say, the joining operation. If the dummy element is reused for various weld seams and/or welding spots, the dummy element may also be produced in a very materially intensive manner, for instance as a solid plate.

It is further particularly simple and advantageous to bring the dummy element into contact with the outer covering metal sheet which is not in contact with the additional component by means of overlapping, in particular when the additional component and the composite sheet metal member are constructed in a planar manner. That is to say, the dummy element is preferably provided on the outer covering metal sheet facing away from the additional component.

The additional component may be a conventional sheet metal component. It is also conceivable for the additional component to be a solid metal component or even a composite material, such as, for example, a composite sheet metal member. In order to ensure the weldability of the composite sheet metal member with the other component, the additional component, if it is not constructed completely of metal, has in particular at least one outer metal layer which can be brought into contact with the composite sheet metal member and welded.

In a first embodiment of the method, at least one current path between the two electrodes may be closed by means of the dummy element and the two outer covering metal sheets. In this manner, it is possible to ensure that there flows through the dummy element a portion of the current which would otherwise flow through an outer covering layer. If the dummy element is provided between an outer covering layer and the electrode so that the current flows through the dummy element into the outer covering layer, or vice versa, the current density may be reduced in the outer covering metal sheet adjacent to the dummy element. However, the dummy element may alternatively or in addition take up a portion of the heat which is produced during the welding operation and consequently discharge it from an outer covering metal sheet. Preferably, the electrode may be brought into abutment with the dummy element in order, for instance, to ensure a current path through the dummy element and, for example, to prevent direct contact between the electrode and the composite sheet metal member. The dummy element is then preferably brought into contact with an electrode which is associated with the composite sheet metal member.

Alternatively or in addition, a current path between the two electrodes may be closed by means of the dummy element and the electrically conductive component. The current path may thus be closed, for example, partially or preferably completely bypassing the composite sheet metal member. It is thus possible to provide a current path which protects the composite sheet metal member or an additional current path which optionally leads to a reduction of the current density in the composite sheet metal member and thus also leads to a material-protecting welding operation with lower thermal loading.

A simple implementation regarding the method can be achieved when the dummy element is received in a receiving member which is connected to the additional component in an electrically conductive manner. In this instance, the receiving member is preferably used at the same time for positioning the dummy element during the welding operation. The receiving or positioning of the dummy element is carried out preferably before the actual joining operation. However, the dummy element may also be received or positioned within given limits only during the joining operation. Alternatively or additionally, the material and the dimensions of the receiving member may also be used as control variables for adjusting current and heat flows. For example, it is conceivable for the resistance of the receiving member to be able to be adjusted by means of a potentiometer or the like.

It is particularly simple to use a receiving member which is fixed with respect to one of the electrodes. It is thus possible for a predetermined relative positioning of the electrode and dummy element to be constantly maintained. Occurrences of incorrect positioning of the dummy element during the joining operation can thus be prevented.

Alternatively or additionally, a plurality of dummy elements which are provided on a carrier belt can be used. This is particularly advantageous when the carrier belt is moved between an electrode and the composite sheet metal member. This is preferably carried out between two joining events, the joining events also being able to relate to two different composite sheet metal members. A joining event is, for example, intended to be understood to involve setting a welding spot or drawing a weld seam. The carrier belt may ultimately be received in a corresponding automatic feeding unit. In this instance, it is also preferable for a retention member for the carrier belt to be fixed relative to an electrode. The positioning is preferably carried out automatically. The carrier belt must then be further transported only by a small amount after a joining event in order to bring a next dummy element into the starting position again for a subsequent joining event.

A simplification relating to the method can be achieved when the plurality of dummy elements are separated before or during the joining of the carrier belt. The separated dummy elements can then be disposed of separately or remain bonded to the composite sheet metal member. The separation can be carried out for the sake of simplicity by the electrode and/or the receiving member for the dummy elements. To this end, the carrier belt may, for example, have perforations and/or the electrode or the receiving member may punch the dummy elements from the carrier belt.

The joining operation can be carried out in such a manner that the dummy element remains bonded to the composite sheet metal member. The dummy element is ultimately welded on during the joining operation. This may lead to suitable joining results. However, it may further be the case that the dummy portion which is bonded to the composite sheet metal member influences the use or the properties of the composite sheet metal member in an undesirable manner. In order to overcome this disadvantage, the dummy element may be at least partially separated from the composite sheet metal member after the joining event. This can be carried out in a particularly simple manner by a torsion force being applied to the dummy element in order, for example, to shear at least portions of the dummy element from the composite sheet metal member. The dummy element may also be completely or partially removed from the composite sheet metal member in a cutting manner using appropriate means. If the dummy element is intended to be partially removed, it may be advantageous for this purpose to provide in the dummy element at least one corresponding desired breaking location which facilitates a separation of remaining dummy portions and dummy portions to be removed.

In principle, dummy elements have an advantageous effect when they comprise a material of high electrical conductivity and high melting temperature. The electrical conductance in the current path via the dummy element and the form stability during the joining operation are thus promoted by the dummy element. In the case of particularly high conductivities and melting temperatures of the dummy element, it is possible for the dummy element not to be joined to the composite sheet metal member. The dummy element can then be used repeatedly for a plurality of joining events, without becoming significantly damaged or having to be separated from the composite sheet metal member again. For the sake of simplicity, and in order to be able to receive larger quantities of heat and to discharge them from the composite sheet metal member, it is possible to use as a dummy element a solid plate whose thickness may significantly exceed the thickness of the composite sheet metal member and/or an outer covering metal sheet.

In order to improve the discharge of the heat produced during the joining operation, it is alternatively or additionally possible to make provision for cooling of the dummy element. If the dummy element is retained in a receiving member, the receiving member may also alternatively or additionally be cooled. Water, oil or another fluid may be used as a cooling medium. The cooling may be carried out via corresponding cooling channels.

It is often not possible to exclude during the joining operation the fact that gases are discharged or gases are released from the at least one non-metal layer of the composite sheet metal member owing to the action of heat. In this instance, a dummy element and/or a receiving member having piercing formations can be used. The formations, for instance, in the form of pins, in this instance extend through an outer covering metal sheet. Gases from a non-metal layer can then be discharged through at least one corresponding ventilation channel.

It has been found that good results are achieved during the joining operation when the dummy element is wider than the weld seam to be anticipated. In the case of a spot welding operation, the same applies to dummy elements having a diameter which is greater than the diameter of the welding spot or the welding zone. With appropriate dummy elements, a sufficient quantity of heat can be discharged and/or the current density in the corresponding current path can be sufficiently reduced.

In a particularly preferred manner, the method described can be used during resistance spot welding operations. In this instance, a high quantity of heat is introduced into the composite sheet metal member only in a localised manner and it is possible to use dummy elements in a particularly simple and cost-effective manner, for instance, in the form of circular sheet metal plates or the like.

The objective which is mentioned in the introduction and which forms the basis of the invention is achieved with a device of the type also mentioned in the introduction according to claim 15 in that a receiving member is provided for receiving a dummy element before and/or during the joining operation and for contacting the dummy element with the composite sheet metal member and in that the receiving member is connected to the additional component in an electrically conductive manner.

The advantages already previously described in connection with the use of at least one receiving member are thereby achieved. Other preferred embodiments of the device according to the invention will also be appreciated from the above description relating to the method. These are readily apparent to the person skilled in the art.

The invention as a whole will be explained in greater detail below with reference to the drawings which merely illustrate embodiments. In the drawings:

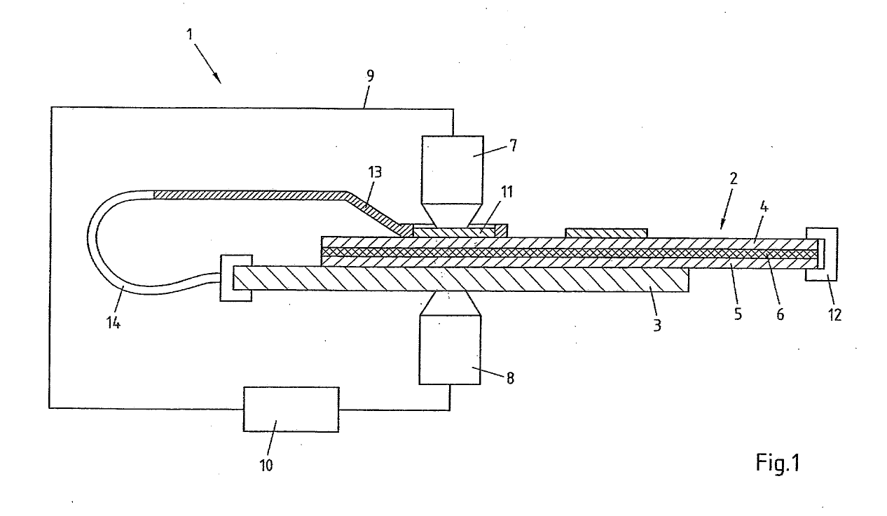

FIG. 1 is a schematic sectioned view of a first embodiment of the device according to the invention when carrying out a first embodiment of the method according to the invention,

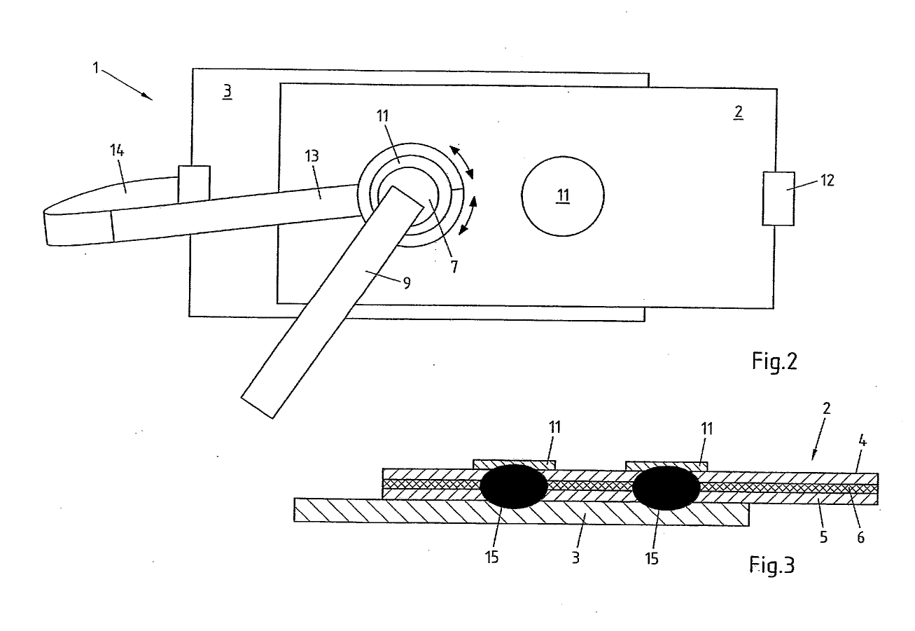

FIG. 2 is a schematic view from above of the device from FIG. 1,

FIG. 3 is a schematic sectioned view of a workpiece produced with the first embodiment of the method according to the invention,

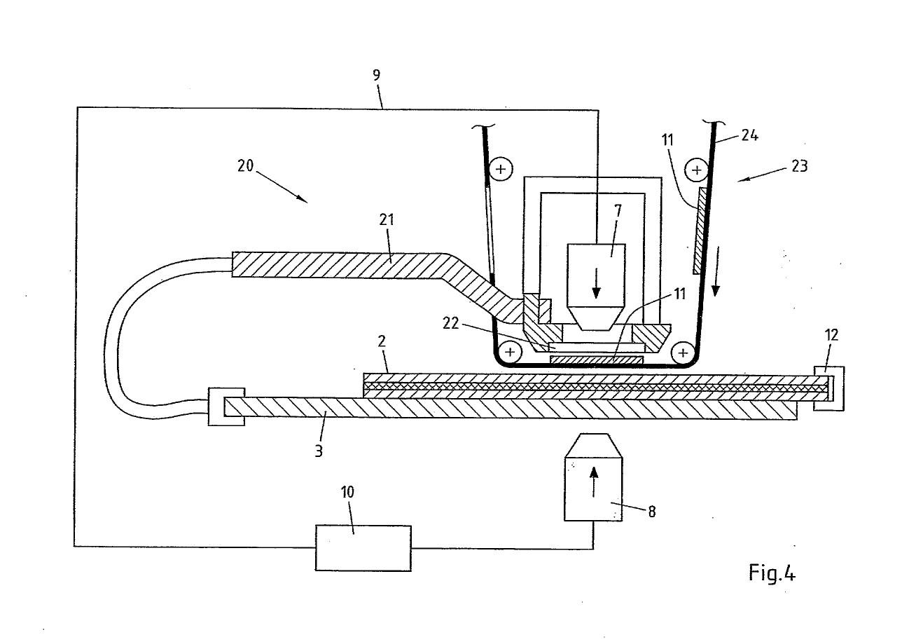

FIG. 4 is a schematic sectioned view of a second embodiment of the device according to the invention when carrying out a second embodiment of the method according to the invention,

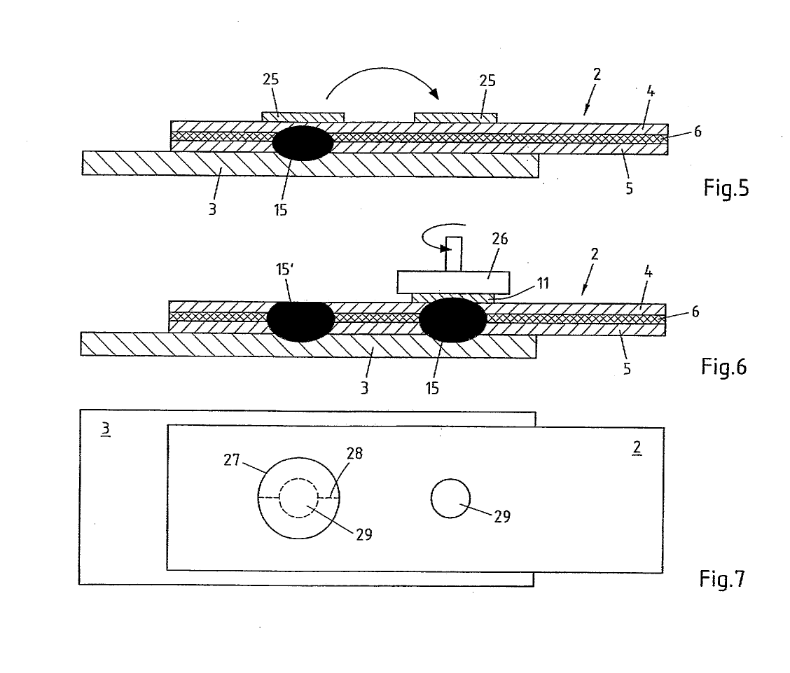

FIG. 5 is a schematic sectioned view of a workpiece produced with a third embodiment of the method according to the invention,

FIG. 6 is a schematic sectioned view of a workpiece when carrying out a fourth embodiment of the method according to the invention,

FIG. 7 is a schematic view from above of a workpiece when carrying out a fifth embodiment of the method according to the invention,

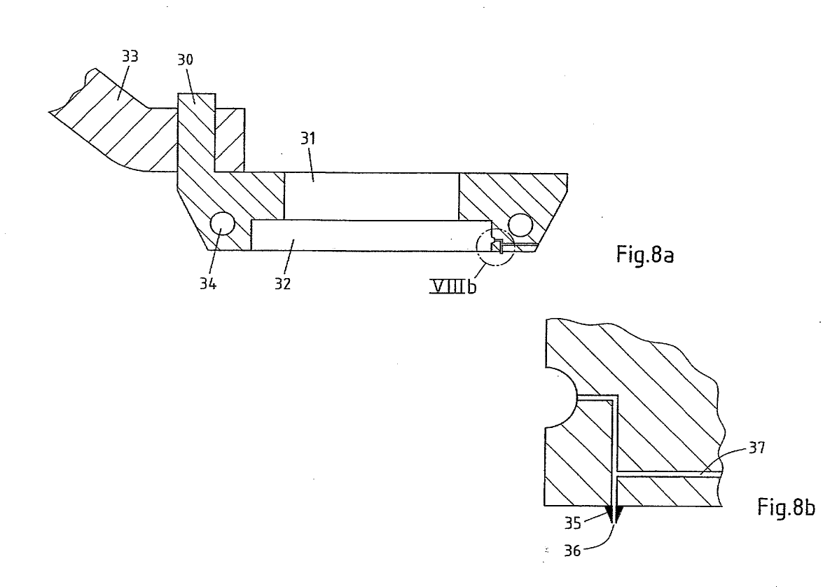

FIGS. 8a-b are sectioned views of a receiving member of a third embodiment of the device according to the invention, respectively,

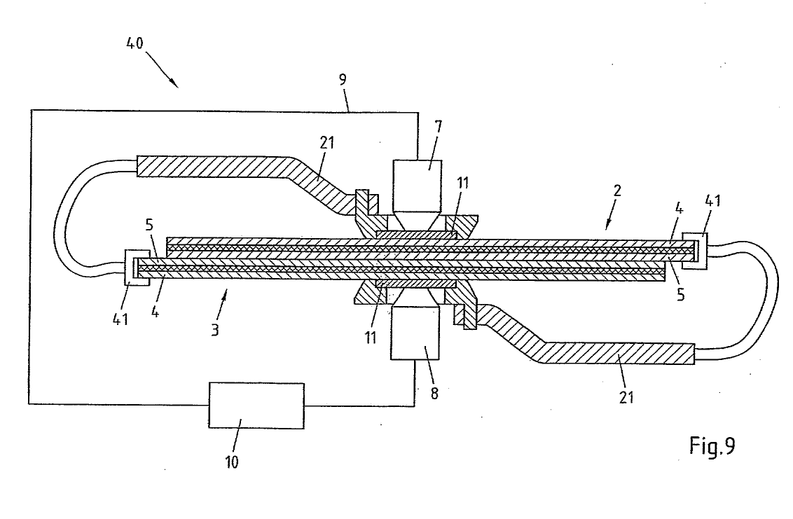

FIG. 9 is a schematic sectioned view of a fourth embodiment of the device according to the invention when carrying out a sixth embodiment of the method according to the invention, and

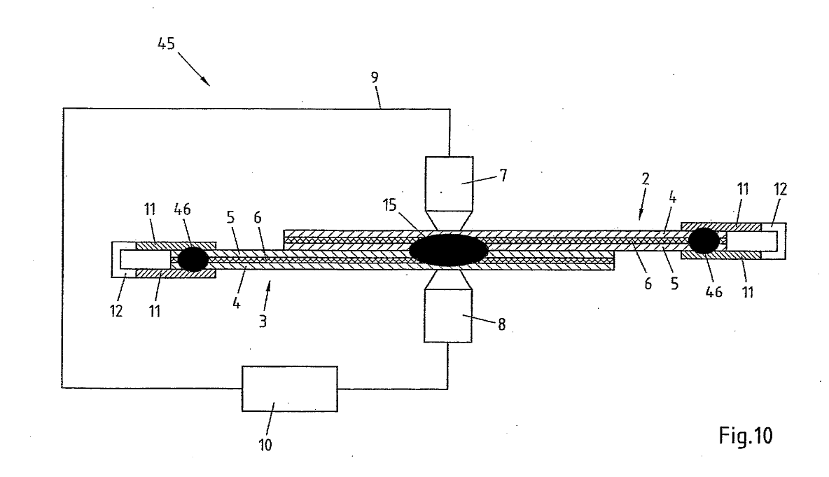

FIG. 10 is a schematic sectioned view of a fifth embodiment of the device according to the invention when carrying out a seventh embodiment of the method according to the invention.

FIGS. 1 and 2 show a device 1 for joining, by means of resistance welding, in particular by means of resistance spot welding. A composite sheet metal member 2 and an additional component 3 are located in the device 1. The composite sheet metal member 2 comprises in the embodiment, which is illustrated and which is preferred in this regard, two outer covering metal sheets 4, 5 and an inner non-metal layer 6 of plastics material, whilst the additional component 3 is formed by a conventional metal sheet.

The composite sheet metal member 2 and the additional component 3 are joined together in the position which is illustrated in FIGS. 1 and 2 and in which they overlap each other, by means of two welding spots. To this end, the composite sheet metal member 2 and the additional component 3 are moved between the two electrodes 7, 8 of a welding pincer 9 of a resistance welding unit, which partially engages around both the composite sheet metal member 2 and the additional component 3. A potential difference is applied across the electrodes 7, 8 of the welding pincer 9 by means of a voltage supply 10 which is not illustrated in greater detail. In this way the lower electrode 8 contacts the additional component 3. The upper electrode 7 contacts a circular-disc-like dummy element 11 which is placed on the outer covering metal sheet 4 facing away from the additional component 3. The dummy element 11 is consequently provided between the outer covering metal sheet 4 and the upper electrode 7 so that direct contact between the electrode 7 and the composite sheet metal member 2 is not produced. In the embodiment illustrated and preferred in this regard, the thickness of the circular-disc-like dummy element 11 is adapted to the welding task. The thickness of the circular-disc-like dummy element 11 may, for example, be approximately 1 mm. In addition, the upper electrode 7 may have a higher contact resistance compared with the lower electrode 8.

At the edge of the composite sheet metal member 2 illustrated at the right-hand side, there is provided a current bridge 12, which slightly engages around the edge of the composite sheet metal member 2 and which is electrically conductive. The current bridge 12 consequently ensures that a current path is formed between the two electrodes 7, 8 by means of the dummy element 11, the upper outer covering metal sheet 4, the current bridge 12, the lower outer covering metal sheet 5 and the additional component 4 during the joining operation. The current bridge 12 thus constitutes an electrically conductive connection between the outer covering metal sheets 4, 5. Another current path between the electrodes 7, 8 is closed by means of the dummy element 11, a receiving member 13, a connection 14 between the receiving member 13 and the additional component 3 and the additional component 3. The parallel construction of the two current paths is the aspect which ensures particularly good joining results.

The receiving member 13 serves to receive the dummy element 11 and to position the dummy element 11 in the desired orientation with respect to the composite sheet metal member 2. To this end, the receiving member 13 is constructed in the form of a pincer so that the receiving member 13 can be expanded or opened in order to introduce the dummy element 11 and can be subsequently narrowed or closed for fixing or in any case contacting. This is illustrated in particular in FIG. 2. To this end, the receiving member 13 may be connected to the welding pincer 9 in a fixed manner, but this is not necessary. Furthermore, the receiving member 13 in the embodiment illustrated is connected by means of a connection 14 in the form of a flexible cable or a strip to the additional component 3, in particular in order to be able to set a plurality of welding spots at different positions of the additional component 3. In the embodiment illustrated, two welding spots are intended to be set. At the location of the second welding spot, another circular-disc-like dummy element 11 is already provided. In order to be able to apply the dummy elements 11 already before the respective joining operation, without the danger of inadvertent displacement becoming involved, or when the surface of the composite sheet metal member extends in an oblique manner, the dummy elements 11 may be adhesively bonded to the composite sheet metal member 2.

FIG. 3 is a lateral cross-section of the workpiece comprising the composite sheet metal member 2 and the additional component 3 after the joining operation. The welding zones 15 of the spot weldings are constructed in a lenticular manner, as so-called welding spots, and have a slightly smaller diameter than the associated dummy elements 11. However, the diameter difference could be significantly larger where applicable. In the embodiment illustrated and preferred in this regard, the welding zones 15 extend at one side into the additional component 3 and at the other side into the outer covering metal sheet 4 which faces away from the additional component 3. Consequently, the dummy elements 11 have also been joined and subsequently also remain bonded to the composite sheet metal member 2.

In the device 20 illustrated in FIG. 4, there is provided a receiving member 21 which has a peripheral recess 22. Dummy elements 11 can be received in this peripheral recess 22 in a precise manner. Furthermore, owing to the receiving member 21 in the form of an undercut portion, very secure positioning of the dummy elements 11 is possible.

Furthermore, in the device 20 illustrated, an only partially illustrated automatic supply system 23 of dummy elements 11 to the individual welding points is provided. To this end, the individual dummy elements 11 are fixed one behind the other on a carrier belt 24. The carrier belt 24 is rolled up and is clamped in the automatic supply system 23. In the period of time between the positioning of two sequential welding spots, the carrier belt 23 is transported further by a small amount until the next dummy element 11 assumes the starting position for the joining operation, which the previous dummy element 11 has already assumed. Afterwards, the welding pincer 9 is closed, the next dummy element 11 being punched out by the electrode 7 and/or the receiving member 21, if necessary. In this instance, the dummy element 11 is contacted with the composite sheet metal member 2 and the resistance spot welding operation per se can be carried out. This is carried out substantially as already described above. In order to facilitate the punching out or in general the separation of the dummy element 11 from the carrier belt 24, the carrier belt 24 may have corresponding weakening portions, for instance in the form of perforations.

In the embodiment illustrated and preferred in this regard, the carrier belt 24 is transported through the space between the composite sheet metal member 2 and the upper electrode 7. However, the transport of the carrier belt 24 could also be carried out outside this intermediate space and the carrier belt 24 could be introduced in each case into the intermediate space after the next dummy element 11 has assumed the desired position in the automatic supply system 23.

A workpiece which is produced with a modified method and which comprises a composite sheet metal member 2 and an additional component 3 is illustrated in cross-section in FIG. 5. The method is modified in this instance in such a manner that the welding zone 15 extends only from the additional component 3 into the outer covering metal sheet 4 of the composite sheet metal member 2 facing away from the additional component 3. In this instance, the dummy element 25 is not securely connected to the composite sheet metal member 2 by the composite sheet metal member 2 being joined to the additional sheet metal component 3. The dummy element 25 can therefore be used again to set the next welding spot, which is illustrated in FIG. 5 by the arrow. In the corresponding method, a particularly conductive and thermally stable dummy element 25 is used. Since the dummy element 25 can be reused, correspondingly higher material costs for the dummy element 25 do not constitute a significant disadvantage.

If the dummy elements 11 are connected during the joining operation to the composite sheet metal member 2, the joining method can be supplemented by a step illustrated in FIG. 6. In this instance, after the joining operation, a rotating stamp 26 or the like is pressed against the dummy element 11 and a torsion force is thus applied to the dummy element 11. If the torsion force or the torque applied to the dummy element 11 is sufficiently large, the dummy element 11 is completely sheared off. The remaining welding zone 15′ is illustrated at the left-hand side in FIG. 6.

FIG. 7 illustrates a workpiece comprising a composite sheet metal member 2 and an additional component 3, which is subjected to a slightly modified method. In this instance, dummy elements 27 are used and have so-called desired breaking locations 28 having reduced material thickness or another weakening of the material. Such a dummy element 27 is illustrated at the left-hand side of FIG. 7. The desired breaking locations 28 which are illustrated with dashed lines are constructed in such a manner that the dummy element 27 is partially destroyed when a torsion force is stamped, as described in relation to FIG. 6. An inner portion 29 of the dummy element 27 directly connected to the welding zone thus remains on the composite sheet metal member 2. The portion 29 of the dummy element 27 remaining on the composite sheet metal member 2 is illustrated at the right-hand side and is approximately the size of the welding spot to be anticipated or the region of the dummy element 27 joined to the composite sheet metal member 2.

FIGS. 8a and 8b show a portion of a receiving member 30 of a device for joining by means of resistance welding. The receiving member 30 illustrated and preferred in this regard has a circular opening 31 and a circular recess 32 which is arranged concentrically relative to the opening 31 and in which a correspondingly constructed dummy element can be received. However, the receiving member and the opening could also be constructed in a manner other than circular and/or not concentrically relative to each other.

The receiving member 30 further has a retention member 33 by means of which the dummy element is connected to the additional component in a conductive manner. In order to cool the receiving member 30, there is provided a cooling channel 34 which is constructed in an annular manner in the receiving member 30 illustrated and preferred in this regard. A cooling medium can flow through the cooling channel 34 in order to discharge the heat generated during the resistance welding operation. In the receiving member 30 illustrated and preferred in this regard, the cooling channel 34 is constructed in such a manner that it is adjacent to the dummy element and adjacent to the composite sheet metal member during the joining operation. Heat can thus be discharged both from the composite sheet metal member and from the dummy element. Alternatively or in addition, the dummy element could have cooling channels which may be ventilated. The cooling channels of the dummy element could also be supplied with a cooling fluid separately or via the receiving member so that cooling medium flows through the cooling channels of the dummy element.

In the receiving member 30 illustrated in FIGS. 8a and 8b and preferred in this regard, there are further provided piercing formations 35 in the form of pins which can extend through an outer covering metal sheet of a composite sheet metal member when the receiving member 30 is pressed against the composite sheet metal member. The piercing formations 35 then protrude into the at least one non-metal layer. Through a hole 36 in each of the piercing formations 35 and a ventilation channel 37 which is connected to these holes 36, gases released in the non-metal layer during the joining operation can be discharged. In the embodiment illustrated and preferred in this regard, the piercing formations 35 are produced from an electrically non-conductive material, for example, ceramic material, in order to prevent the formation of sparks which may occur in the event of high welding currents.

FIG. 9 shows a device 40 for joining two composite sheet metal members 2 by means of resistance welding. The basic principle of the joining operation corresponds to the previously described principle, with the specific feature that the additional component 3 is also a composite sheet metal member. A dummy element 11 is therefore introduced between each electrode 7, 8 of the welding pincer 9 and the associated composite sheet metal member 2 or the additional component 3 in the form of a composite sheet metal member, by means of a receiving member 21 of the type already described. Each receiving member 21 is connected to the opposite composite sheet metal member 2 or the additional component 3 in an electrically conductive manner. These connections 14 are each provided by means of a current bridge 41, respectively, which current bridges themselves connect the two outer covering metal sheets 4, 5 of the composite sheet metal member 2, on the one hand, and the additional component 3, on the other hand, to each other in an electrically conductive manner. In this manner, four different current paths are produced between the two electrodes 7, 8. Each of these current paths extends in this instance through both dummy elements 11 since both electrodes 7, 8 are each in conductive contact with the workpiece exclusively via a dummy element 11. Two of the current paths extend through an outer covering metal sheet 4, respectively. A current path extends through the two outer covering metal sheets 5 which touch each other and another current path through all four outer metal covering sheets 4, 5.

FIG. 10 shows a device 45 which is modified with respect to the device 40 shown in FIG. 9 for joining a composite sheet metal member and an additional component 3 which is in the form of a composite sheet metal member by means of resistance welding. In the method which is carried out with this device 45, the use of receiving members for receiving dummy elements is dispensed with. A dummy element 11 is also not provided in each case between the electrodes 7, 8 and the composite sheet metal member 2, on the one hand, and the additional component 3 which is constructed as a composite sheet metal member, on the other hand. Instead, the outer covering metal sheets 4 of the composite sheet metal member 2 and the additional component 3 are connected to each other in an electrically conductive manner by means of two dummy elements 11 and a current bridge 12, respectively, the covering metal sheets 4, 5 each being directly in abutment against a dummy element 11.

During the joining operation, there is produced only one current path between the two electrodes 7, 8 which extends through all four outer metal covering sheets 4, 5 and all four dummy elements 11. In this instance, the contact faces between each individual dummy element 11 and the corresponding outer covering metal sheet 4, 5 are sufficiently small so that not only the composite sheet metal member 2 is joined to the additional component 3 in the form of a composite sheet metal member but in addition the outer covering metal sheets 4, 5 of the composite sheet metal member 2, on the one hand, and the additional component 3, on the other hand, as the welding zones 15, 46 illustrated in FIG. 10 show. The dummy elements 11 may also be joined to the associated outer covering metal sheets 4, 5. However, a subsequent separation of the dummy elements 11 from the outer metal covering sheets 4, 5 is possible, if necessary.

1-14. (canceled)

15. A method for joining a composite sheet metal member to an additional component, the composite sheet metal member having at least two outer covering metal sheets and at least one non-metal layer which is arranged between the covering metal sheets and the additional component having at least one outer metal layer,
moving the composite sheet metal member and the additional component so as to overlap each other between two electrodes of a resistance welding unit,
moving an electrically conductive dummy element into abutment with at least one of the outer covering metal sheets and
closing at least one current path between the two electrodes by means of an electrically conductive dummy element, and
closing a current path between the two electrodes by means of the dummy element and the additional component with the composite sheet metal member being partially or completely by-passed.

16. The method according to claim 15, wherein the current path between the two electrodes is closed by means of the dummy element and the at least two outer covering metal sheets.

17. The method according to claim 16, wherein the dummy element is brought into abutment with an electrode which is associated with the composite sheet metal member.

18. The method according to claim 17, wherein the dummy element is received in a receiving member which is connected to the additional component in an electrically conductive manner during and/or before the joining operation.

19. The method according to claim 18, wherein a receiving member which is fixed with respect to one of the electrodes is used.

20. The method according to claim 15, wherein a plurality of dummy elements are provided on a carrier belt and wherein the carrier belt is preferably moved through the intermediate space between an electrode and the composite sheet metal member.

21. The method according to claim 20, wherein the plurality of dummy elements are separated by the electrode and/or the receiving member from the carrier belt.

22. The method according to claim 15, wherein the dummy element is connected to the composite sheet metal member during the joining operation and wherein the dummy element, after the joining operation, is at least partially separated from the composite sheet metal member, preferably sheared or removed in a cutting manner.

23. The method according to claim 15, wherein the dummy element comprises a material of high electrical conductivity and high melting temperature, the dummy element is not joined to the composite sheet metal member and wherein the dummy element is reused for a plurality of joining events.

24. The method according to claim 15, wherein the receiving member and/or the dummy element is/are cooled, preferably water-cooled.

25. The method according to claim 15, wherein a receiving member having piercing formations is used in order to penetrate an outer covering metal sheet and, preferably, in order to degas a non-metal layer.

26. The method according to claim 15, wherein the dummy element is wider than the welding zone to be anticipated.

27. The method according to claim 15, wherein the joining operation is a resistance spot welding operation.

28. A device for joining a composite sheet metal member to an additional component comprising:
a composite sheet metal member having at least two outer covering metal sheets and at least one non-metal layer which is arranged between the covering metal sheets and the additional component having at least one outer metal layer; and
a resistance welding unit comprising at least two electrodes and having a receiving member for receiving a dummy element before and/or during the joining operation and for contacting the dummy element with the composite sheet metal member, the receiving member being connected to the additional component in an electrically conductive manner.
